(19) United States
(12) Patent Application Publication
(10) Pub. No.: US 2025/0144532 A1
(43) Pub. Date: May 8, 2025

(54) A LAUNCH SYSTEM FOR AN AMUSEMENT VEHICLE RIDE, AS WELL AS AN AMUSEMENT VEHICLE RIDE AND A RELATED METHOD

(71) Applicant: Electroproject B.V., EH ZAANDAM (NL)

(72) Inventors: Martinus Cornelis Petrus JONKER, EH ZAANDAM (NL); Juan Antonio CATENA ORTEGA, EH ZAANDAM (NL); Palmiro Melis STISSI, EH ZAANDAM (NL)

(21) Appl. No.: 18/837,399

(22) PCT Filed: Feb. 13, 2023
(86) PCT No.: PCT/NL2023/050063

§ 371 Date: Aug. 9, 2024

(30) Foreign Application Priority Data
Feb. 11, 2022 (NL) 2030899

(51) Int. Cl. A63G 31/00; H02J 3/32

(52) U.S. Cl. CPC A63G 31/00; H02J 3/32; H02J 2207/30

(57) ABSTRACT

A launch system for an amusement vehicle ride, said launch system comprising a Direct Current, DC, bus having a DC bus voltage, a power input arranged to be connected to an Alternating Current, AC, power grid, a rectifier arranged for receiving AC power via said power input, and for converting said AC power to a Direct Current, DC, power, and for providing said DC power to said DC bus, an auxiliary power supply connected to said DC bus for providing said DC bus voltage, a DC/AC converter having an input connected to said DC bus and an output arranged to be connected to one or more motors for driving said amusement vehicle ride, said DC/AC converter arranged for converting said DC power to an AC power for providing said AC power to said one or more motors, wherein said DC/AC converter is arranged to provide at least 1000 A to said one or motors, a controller for controlling said DC/AC converter, wherein said auxiliary power supply comprises a plurality of battery cells.

### TECHNICAL FIELD

The present disclosure is directed to the fields of launch system and, especially, to a system that is able to provide a large amount of power for a short amount of time such that it can drive one or more motors of an amusement vehicle ride.

### BACKGROUND

Launch systems for an amusement vehicle ride already exist in the art. Multiple launch systems are known in the art. One of such known launch systems is related to a flywheel generator to store energy from a grid and to deliver the energy to a particular amusement park ride. Such a flywheel generator is costly and huge in size and therefore undesirable.

Another option is to use a launch system that utilizes ultra-capacitors, i.e. supercapacitors. One of the advantages of using ultra-capacitors is that they are able to provide a huge discharge current that is needed for these launch systems of amusement vehicle rides. In such a launch system, the ultra-capacitors are charged in each cycle of the vehicle ride. The ultra-capacitors are charged during the ride such that they have sufficient energy stored for the next launch of the ride. The launch of a ride typically only takes a couple of seconds in which the ultra-capacitors are discharged. A DC/AC converter may be connected to the ultracapacitors to convert the DC power stored in the ultra-capacitors to AC power that is used by one or more electrical motors for driving/launching the vehicle ride.

One of the downsides of such a launch system is that they cannot cope with temporary power failures of the AC mains grid. The ultra-capacitors are no longer charged anymore if such a power failure occurs, leading to downtime of the amusement vehicle ride which is undesirable.

### SUMMARY

It is an object of the present disclosure to provide for a launch system for an amusement vehicle ride that is able to cope with power failures of the AC mains power grid.

In a first aspect of the present disclosure, there is provided a launch system for an amusement vehicle ride, said launch system comprising:
a Direct Current, DC, bus having a DC bus voltage;
a power input arranged to be connected to an Alternating Current,
AC, power grid;
an auxiliary power supply connected to said DC bus for providing said DC bus voltage and comprising a plurality of battery cells arranged to provide at least 150 kilowatt;
a DC/AC converter having an input connected to said DC bus and an output arranged to be connected to one or more motors for driving said amusement vehicle ride, said DC/AC converter arranged for converting said DC power to an AC power for providing said AC power to said one or more motors,
a controller for controlling said DC/AC converter,

wherein the launch system further comprises
a bidirectional rectifier, arranged for
   receiving AC power via said power input, and for converting said AC power to a Direct Current, DC, power, and for providing said DC power to said DC bus, and for
   receiving DC power from via said DC bus, and for converting said DC power to said AC power for injecting said AC power into said AC power grid.

The inventors have found that it might be beneficial to use a plurality of battery cells in the launch system for providing the power that is required during launch of the amusement vehicle ride. The plurality of battery cells typically have much more energy capacity than what is required for a particular launch of the amusement vehicle ride. The discharge current of a battery is typically relatively low, such that many battery cells are required to achieve the particular discharge current. As a consequence, the battery cells are over dimensioned.

The inventors have found that it is still beneficial to use such battery cells, as the battery cells may provide power to the amusement vehicle ride in case of power shortage, i.e. when the AC grid fails. The total energy capacity of the system may be sufficient to launch the amusement vehicle ride a couple of times, i.e. without an AC grid being able to replenish the battery cells.

It was further found that the battery cells may be used to inject power back into the AC grid. To do so, the launch system may comprise a bidirectional rectifier, for example an active front end, AFE, that is able to convert AC to DC, i.e. from AC grid to the DC bus voltage, but also the other way around, i.e. from DC to AC, i.e. from DC bus voltage to the AC grid. This allows the energy stored by the plurality of battery cells to be converted to the AC voltage, for example in situations wherein the AC grid malfunctions.

Using battery cells for this purpose is counter intuitive as, typically, battery cells are not ought to be suitable for providing a discharge current that is high enough for this particular purpose. However, the inventors have found that battery cells might still be useful given that the electrical storage capacity of the system is to be increased to ensure that the launch system is capable to cope with power failures of the AC power grid.

The total electrical storage capacity of the launch system may be designed in such a way that the total amount of electrical energy stored at a certain moment in time is sufficient for launching the amusement park ride for a plurality of times. This allows the amusement vehicle ride to operate even during power shortages or power failures of the AC power grid. The present disclosure further defines that the energy stored by the plurality of battery cells may be converted back to AC, to inject into the AC grid. For example to empower other electrical systems within the amusement park.

It is noted that the plurality of battery cells may be comprised by a battery energy storage system. A battery energy storage system, BESS, is an electrochemical device that charge, or collects energy, from the Alternating Current, AC, grid or a power plant and then discharges that energy at a later time to provide electrical power to the at least one motor.

An amusement vehicle ride is, for example, a roller coaster, which is considered a type of amusement ride that employs a form of elevated railroad track designed with tight turns, steep slopes, and sometimes inversions. Passengers ride along the track typically in open cars, and the rides are often found in amusement parks and theme parks around the world.

It is noted that not all roller coasters use a lift hill. A vehicle ride may also be set into motion by a launch mechanism such as a flywheel, linear induction motor, linear synchronous motor, hydraulic launch, or drive tire. Some launched roller coasters are capable of reaching greater speeds using less track when compared to traditional coasters that rely on a conventional lift hill. The present disclosure is directed to a launch system for such a vehicle ride.

It is further noted that the launch system in accordance with the present disclosure may be used in an amusement park but also at a fair or anything alike.

In an example, each of said plurality of battery cells are arranged for discharging with at least four times, preferably at least six times, and even more preferably around 10 times its rated capacity.

The plurality of battery cells are to be deployed in a launch system that should be capable of launching an amusement vehicle ride for many, many times. For example, the plurality of battery cells should be able to launch the amusement vehicle ride for tens of thousands of times. This sets particular requirements on the plurality of battery cells. The inventors have found that innovation of battery cells have resulted in a situation that battery cells may be considered for this particular purpose.

In an example, the plurality of battery cells are arranged to provide a discharge current for at least 80.000 times, preferably at least 200.000 times and even more preferably 800.000 times, for example during the life time of the plurality of battery cells.

The above is also counter intuitive for a skilled person in the art. Typically, batteries are not designed for providing that many discharge currents during their life span. However, recent developments in battery technology have led to the situation that batteries may be considered for this particular purpose. The inventors have realized this concept.

In a further example, the capacity of the plurality of battery cells is at least 5 times the energy provided during one launch of the amusement vehicle ride, preferably at least 25 times and even more preferably at least 100 times.

The duration of said launch of said amusement park vehicle is, for example, between 2-10 seconds, preferable between 3-6 seconds. The present disclosure may thus be directed to the situation that a particular vehicle ride is actually launched. Other vehicle rides may be towed to a highest point, before the vehicle ride is released. The vehicle ride then completes the ride without any additional thrust or force, just by relying on the gravity force. The launch system in accordance with the present disclosure may not be applicable for such a vehicle ride.

It is noted that the launch system may also be used for other applications. For example, a vehicle ride may need an extra boost during the ride, which power required for this particular boost may also be provided by the launch system of the present disclosure.

In a more detailed example, the plurality of battery cells are arranged to provide a DC voltage of between 500 volt DC-1200 volt DC.

In a typical example, discharge currents in the range of 1000-6000 Amperes need to be reached for launching a vehicle ride. Such currents need to be delivered at, for example, 1000 volt DC.

The charge current may, typically, be much lower. The battery needs to be able to provide the discharge current for a couple of seconds, for example during the launch of the vehicle ride, while the charge current may be provided during the ride itself. The ride itself may take up to one minute or anything alike. As such, the charge current may be one order of magnitude smaller compared to the charge current, for example 100 Amperes-600 Amperes at, for example, 1000 volt DC.

The charge current may be provided by the AC power grid, by solar panels, by a generator or anything alike. The plurality of battery cells may be charged during the day and/or at night. The plurality of battery cells may be charged in between rides, during the rides, or in a continuous manner.

In an example, the controller is further arranged for controlling said rectifier.

For example, the controller may be arranged for controlling said rectifier such that said DC bus voltage is controlled between 500 volt DC-1200 volt DC.

In a further example, the launch system further comprises a switch in between said DC bus and said power input for connecting and disconnecting said AC power grid to said DC bus, for example between said rectifier and said AC power grid and between said DC bus and said rectifier.

One of the advantages of using such a switch is that the AC power grid may be disconnected from the DC bus whenever the vehicle ride is actually launched. This prevents undesired high currents to be provided by the AC power grid itself, and ensures that the power is provided by the plurality of battery cells.

Yet another advantage may relate to safety of operation. The launch system for the amusement vehicle ride may be disconnected, as a whole, from the AC power grid to prevent undesired hazards.

It is further noted that an additional DC/DC converter, for example a boost converter, may be placed in between the plurality of battery cells and the DC bus, for converting a voltage provided by the plurality of battery cells to the DC bus voltage.

In a further example, the plurality of battery cells are arrange din multiple parallel strings of batteries. An Auxiliary Management System may be provided for controlling individual connections of each of the strings to the DC bus, thereby improving the lifespan of the launch system, more particularly of the auxiliary power supply.

In a second aspect of the present disclosure, there is provided an amusement vehicle ride, comprising a launch system in accordance with any of the previous examples and comprising one or more motors for driving the amusement vehicle ride.

In a third aspect of the present disclosure, there is provided a method of operating a launch system in accordance with any of the examples provided above, wherein the method comprises the steps of:
providing, by said auxiliary power supply, said DC bus voltage, and
providing, by said auxiliary power supply, said DC power to said DC/AC converter for powering said one or more motors.

In an example, the method comprises the step of:
controlling, by said controller, said DC/AC converter such that it is providing said AC power during launch of said amusement vehicle ride.

In a further example, a duration of said launch of said amusement vehicle ride is between 2-10 seconds, preferable between 3-6 seconds.

In another example, the controller is further arranged for controlling said rectifier, and wherein said method comprises the step of:
controlling, by said controller, said rectifier such that said DC bus voltage is controlled between 500-1200 volt DC.

In a fourth aspect, there is provided a computer program product comprising a computer readable medium having instructions stored thereon which, when executed by a launch system cause said launch system to operate according to a method in accordance with any of the examples provided above.

These and other aspects of the invention will be apparent from and elucidated with reference to the embodiment(s) described hereinafter.

### BRIEF DESCRIPTION OF THE DRAWINGS

FIG. 1 shows an example of a launch system for an amusement vehicle ride in accordance with the present disclosure.

FIG. 2 shows another example of a launch system for an amusement vehicle ride in accordance with the present disclosure.

FIG. 3 discloses a typical example of a launch system in accordance with the present disclosure.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single example of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same example.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention. Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

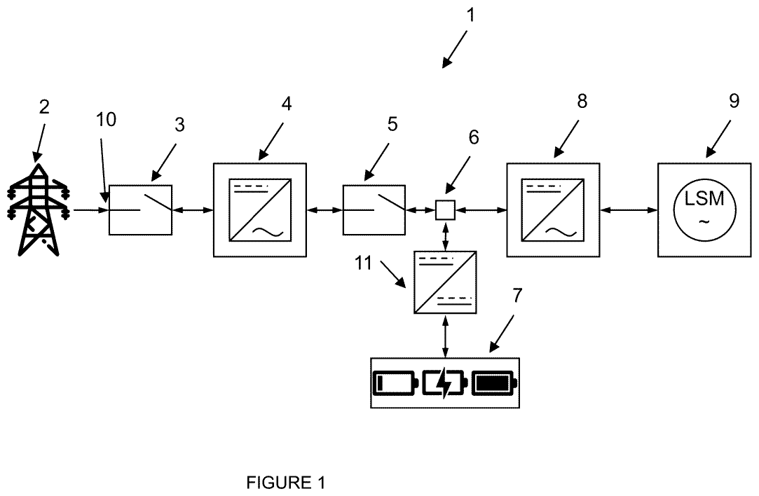

FIG. 1 show a launch system 1 for an amusement vehicle ride. The launch system is indicated with the reference numeral 3, 4, 5, 6, 7, 8 and 10 and will be explained in more detail here below.

The launch system comprises a Direct Current, DC, bus 6 having a DC bus voltage. The bus voltage may be, for example, somewhere between 500 volt DC and 1200 volt DC. The bus voltage may also depend, to a certain extent, on the AC voltage that is provided by the AC power grid 2, for example somewhere between 380 volt AC and 690 volt AC.

A power input 10 is provided which is arranged to be connected to the AC power grid 2. The power input 10 may be any of a connector, cable, utility cabinet, power cabinet, or anything alike. It may be considered the point at which the launch system is to be connected to the AC power grid 2.

It is noted that, in accordance with the present disclosure, the power input 10 alternatively may be connected to any other type of power source, for example battery storage and/or electrical power generators. It is further noted that the launch system may comprise one or more solar panels for charging the plurality of battery cells. If so, additional converters, for example DC/DC converters, may be implemented to convert the voltage provided by the solar panels to the DC bus voltage. Alternatively, for example if one or more converters are present between the DC bus and the plurality of battery cells, the solar panels may directly charge the plurality of battery cells via one or more converters.

The launch system may further comprise a rectifier 4 for receiving AC power via the power input, from the AC power grid 2, and for converting the AC power to a Direct Current, DC, power and for providing the DC power to the DC bus 6.

A rectifier is an electrical device that converts alternating current, which periodically reverses direction, to direct current, which flows in one or both direction. The corresponding process is also known as rectification, since it “straightens” the direction of current.

It is noted that the bidirectional rectifier, in accordance with the present disclosure, may also encompass an active front end.

An auxiliary power supply 7 is provided that is connected to the DC bus 6 for providing the DC bus voltage. Characterizing for the present disclosure is that the auxiliary power supply 7 comprises a plurality of battery cells.

The plurality of battery cells may comprise premium lithium cells. One of the cells that is suitable to be used within the present disclosure may be the EP-LFP-40 Ah from the company Lithium system. Such a cell is able to provide a large discharge current of at least 6 C. A couple of those cells may be connected to each other, in series and/or in parallel, to form a plurality of battery cells suitable to be used within a launch system for driving motors of a amusement park ride.

The launch system 1 may further comprise a DC/AC converter, i.e. an inverter, 8 having an input connected to said DC bus and an output arranged to be connected to one or more motors for driving said amusement vehicle ride, said DC/AC converter arranged for converting said DC power to an AC power for providing said AC power to said one or more motors, wherein said DC/AC converter is arranged to provide at least 1000 A to said one or motors. It is noted that the launch system is used for launching an amusement park ride, and the rating of at least 1000 A makes it suitable to do so. Finally, a controller (not shown) may be included for controlling the inverter.

The one or more motors may be any type of electrical motor and, preferably, linear synchronous motors or linear induction motors.

In accordance with the present disclosure, the launch system may additionally comprises a switch in between said rectifier 4 and said power input 10 for connecting and disconnecting said AC power grid 2 to said rectifier 4.

The switch may be used to ensure that the power required for launching the vehicle ride is not provided by the AC power grid 2 but is provided by the battery 7. The switch 3 may also used for efficiency or safety reasons. The switch may be controlled by the controller. The controller may, for example, enable or disable the switch based on the state of charge of the battery 7. It may be desirable to have the battery 7 operating in a particular state of charge window, for example charged to 90% and then discharged to 60% or anything alike. The switch 3 may accomplish just that.

A further switch 5 may be provided for redundancy purposes or for safety measures. This will ensure that the rectifier 4 may be cut off from the DC power bus 6 as well as from the AC power grid 2.

Finally, a DC/DC converter 11 may be implemented to convert voltages between the DC bus and the plurality of battery cells.

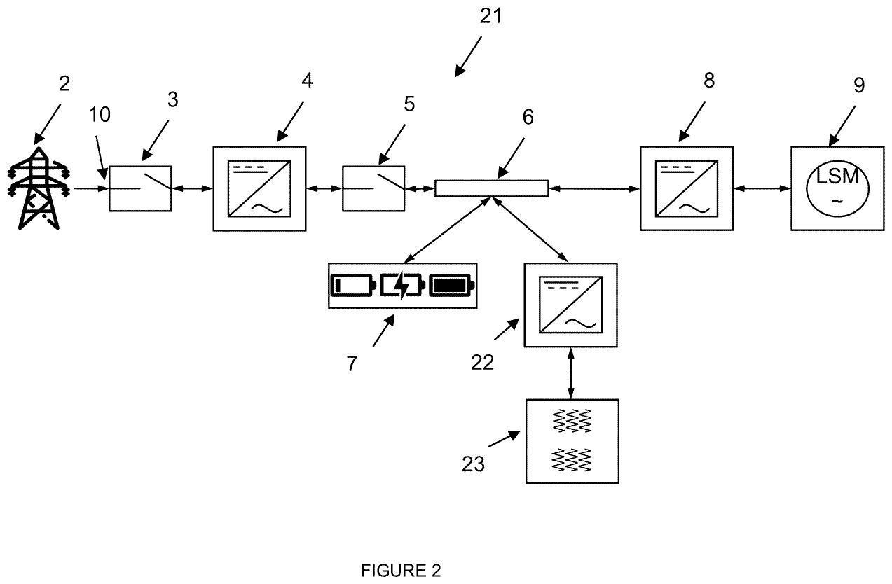

FIG. 2 shows another example of a launch system 21 for an amusement vehicle ride in accordance with the present disclosure.

In addition to the launch system 1 shown in FIG. 1, a brake chopper 22 may be provided, which brake chopper 22 is directly connected to a brake resistor 23. The brake chopper 22 in combination with a brake resistor 23 may be used for actively braking the vehicle ride whenever the ride is either going to fast, or whenever the ride is approaching its final destination. Alternatively the combination of the component 22 and 23 may be used, or may additionally be used, as a kinetic energy recovery system, which is an automotive system for recovering a moving vehicle's kinetic energy under braking. The recovered energy may be stored in the battery 7.

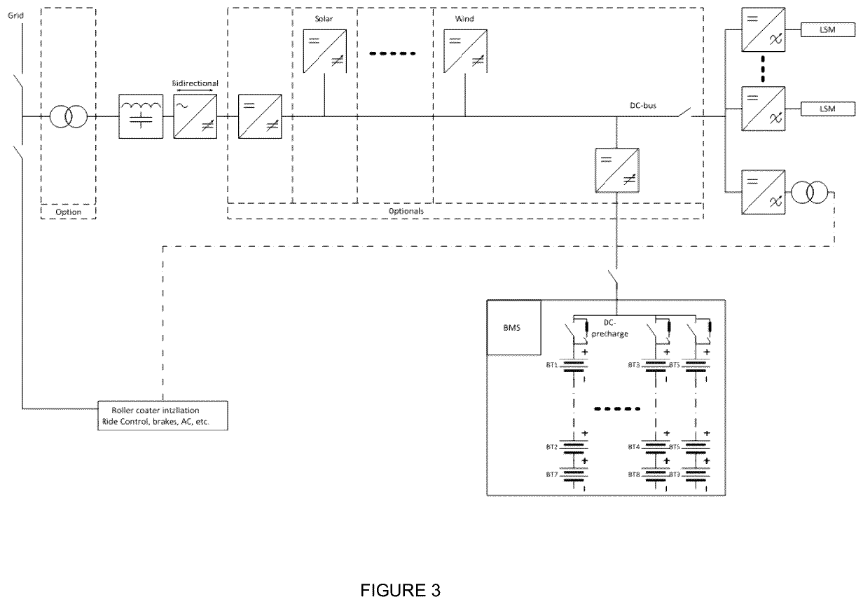

FIG. 3 discloses a typical example of a launch system in accordance with the present disclosure.

The bidirectional rectifier is indicated with the wording “bidirectional”, where it is made clear that the power may flow from the AC grid to the DC bus, or vice versa. Optional elements may be indicated with the wording “optionals” or “option”.

Other variations to the disclosed embodiments can be understood and effected by those skilled in the art in practicing the claimed invention, from a study of the drawings, the disclosure, and the appended claims. In the claims, the word “Comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage.

Any reference signs in the claims should not be construed as limiting the scope thereof

1. A launch system for an amusement vehicle ride, said launch system comprising:
a Direct Current, DC, bus having a DC bus voltage;
a power input arranged to be connected to an Alternating Current, AC, power grid;
an auxiliary power supply connected to said DC bus for providing said DC bus voltage and comprising a plurality of battery cells arranged to provide at least 150 kilowatt;
a DC/AC converter having an input connected to said DC bus and an output arranged to be connected to one or more motors for driving said amusement vehicle ride, said DC/AC converter arranged for converting said DC power to an AC power for providing said AC power to said one or more motors,
a controller for controlling said DC/AC converter,
wherein the launch system further comprises
a bidirectional rectifier, arranged for
receiving AC power via said power input, and for converting said AC power to a Direct Current, DC, power, and for providing said DC power to said DC bus, and for
receiving DC power from via said DC bus, and for converting said DC power to said AC power for injecting said AC power into said AC power grid.

2. A launch system in accordance with claim 1, wherein each of said plurality of battery cells are arranged for discharging with at least four times, preferably at least six times its rated capacity, and even more preferably around ten times its rated capacity.

3. A launch system in accordance with claim 2, wherein said plurality of battery cells are arranged to provide a discharge current for at least 80.000 times, preferably at least 200.000 times and even more preferably 800.000 times.

4. A launch system in accordance with claim 1, wherein a capacity of said plurality of battery cells is at least 5 times the energy provided during one launch of said amusement vehicle ride, preferably at least 25 times and even more preferably at least 100 times.

5. A launch system in accordance with claim 1, wherein said launch system further comprises a converter in between said plurality of battery cells and said DC bus.

6. A launch system in accordance with claim 1, wherein said plurality of battery cells are arranged in multiple parallel strings of batteries.

7. A launch system in accordance with claim 6, wherein said auxiliary power supply comprises an Auxiliary Management System for controlling individual connections of each of said strings to said DC bus.

8. A launch system in accordance with claim 1, wherein said launch system further comprises an AC switch for connecting, and disconnecting, said AC power grid to said power input.

9. A launch system in accordance with claim 1, wherein said launch system further comprises:
an additional power supply for providing additional DC supply power,
an additional DC/DC converter for converting the additional DC supply power to DC power, and for providing said DC power to said DC bus.

10. A launch system in accordance with claim 9, wherein said additional power supply is any of:
a solar power system;
a wind power system.

11. A launch system in accordance with claim 1, wherein said launch system further comprises a converter in between said plurality of battery cells and said DC bus.

12. A launch system in accordance with claim 1, wherein the launch system is incorporated into an amusement vehicle ride, the amusement vehicle ride comprising one or more motors for driving said amusement vehicle ride.

13. A method of operating a launch system in accordance with claim 1, wherein said method comprises the steps of:
providing, by said auxiliary power supply, said DC bus voltage, and
providing, by said auxiliary power supply, said DC power to said DC/AC converter for powering said one or more motors, and
providing, by said auxiliary power supply, said DC power to said AC grid.

14. A method in accordance with claim 13, wherein said method comprises the step of:
controlling, by said controller, said DC/AC converter such that it is providing said AC power during launch of said amusement vehicle ride.

15. A method in accordance with claim 14, wherein a duration of said launch of said amusement vehicle ride is between 2-10 seconds, preferable between 3-6 seconds.

16. A method in accordance with claim 13, wherein said controller is further arranged for controlling said rectifier, and wherein said method comprises the step of:
controlling, by said controller, said rectifier such that said DC voltage is controlled between 500 volt DC and 1200 volt DC.

17. A non-transitory computer readable medium having instructions stored thereon which, when executed by a launch system cause said launch system to operate according to a method in accordance with claim 1.
